(19) United States
(12) Patent Application Publication
(10) Pub. No.: US 2025/0050951 A1
(43) Pub. Date: Feb. 13, 2025

(54) LAND VEHICLE STRUCTURE WITH REINFORCING PARTS FOR TRANSMITTING A TRANSVERSE FORCE

(71) Applicant: STELLANTIS AUTO SAS, POISSY (FR)

(72) Inventors: Mihaela Maria MAGAS, AUTREY LES CERRE (FR); Sebastien MAURICE, SOCHAUX (FR); Ronan BREAL, BETHONCOURT (FR); Manaf KARKAR, BOUSKOURA (MA)

(21) Appl. No.: 18/718,352

(22) PCT Filed: Nov. 16, 2022
(86) PCT No.: PCT/FR2022/052108

§ 371 Date: Jun. 10, 2024

(30) Foreign Application Priority Data
Dec. 16, 2021 (FR) 2113697

(51) Int. Cl. B62D 25/08

(52) U.S. Cl. CPC B62D 25/082; B62D 25/088

(57) ABSTRACT

The invention relates to a structure (SV) fitted to a land vehicle, the structure comprising a front portion having upper arms, each of which comprises front and rear ends, supporting elements (EP2) that are fixedly secured to the rear ends, a transverse stiffener (RT) having first lateral ends (EL12) that are opposite and fixedly secured to the supporting elements (EP2), and two reinforcing parts (PR2) that are shaped so as to be highly resistant to buckling, and are fixedly secured to sub-portions of a carrier element (EP2) and of a first lateral end (EL12) which are associated with one another in order to allow the transmission between supporting elements (EP2) of a portion of a transverse force absorbed by one of them in the event of the front end of the associated upper arm being subjected to an impact.

### CROSS-REFERENCE TO RELATED APPLICATIONS

This application is the US National Stage under 35 USC § 371 of International Application No. PCT/FR2022/052108, filed Nov. 16, 2022, which claims the priority of French application 2113697 filed on Dec. 16, 2021, the content (text, drawings and claims) of both said applications being incorporated by reference herein.

### BACKGROUND

The devices described herein relate to land vehicles, and more specifically to structures which form part of the front portions of such vehicles.

Some land vehicles, generally of the motor vehicle type, comprise, as shown in FIG. 1, a front portion comprising a structure SV having in particular two upper arms BSj, right (j=1) and left (j=2), two supporting elements EPj, right (j=1) and left (j=2), and a transverse stiffener RT.

The two upper arms BSj each comprise front ends EV and rear ends ER, and are generally located above what is known to a person skilled in the art as “shafts” BRj, right (j=1) and left (j=2), also forming part of the structure. Note that the two shafts BRj are generally positioned above what is known by a person skilled in the art as “frame extensions” PBj, right (j=1) and left (j=2), as shown in FIG. 1.

The rear ends ER of the upper arms BSj and front suspensions (not shown) are fixedly secured to the two supporting elements EPj respectively.

The transverse stiffener RT has first lateral ends EL1j that are opposite and fixedly secured respectively to the supporting elements EPj. It is generally part of a canopy assembly EA, which also comprises a collector CA and a transverse strut bar BAT having two second lateral ends EL2j that are opposite and respectively associated with two support parts PSj that are respectively secured to the supporting elements EPj.

When the (land) vehicle is traveling at high speed and is subject to a partial frontal (or “small overlap”) impact with a rigid object such as, for example, a wall, the front end EV of one of the two upper arms BSj suffers the impact. Said upper arm BSj will then transmit a transverse force to the supporting element EPj, to which it is fixedly secured, which will deform it and cause an upward deformation of the transverse strut bar BAT which is coupled to the upper face thereof (at the level of the suspension cup CS thereof) via the associated support part PSj. As the transverse strut bar BAT is unable to perform its function properly and the first lateral end EL1j of the transverse stiffener RT is not sufficiently resistant to buckling, multiple deformations occur, which contribute to the embedding of the vehicle into the object.

The described devices therefore particularly aim to improve the situation in the event of a partial frontal (or small overlap) impact with a rigid object.

### SUMMARY

For this purpose, described herein is a structure designed to form part of the front portion of a land vehicle and comprising, firstly, right and left upper arms, each comprising front and rear ends, secondly, right and left supporting elements, to which the rear ends of the upper arms are respectively fixedly secured, and, thirdly, a transverse stiffener having first lateral ends that are opposite and respectively fixedly secured to the supporting elements.

This structure is characterized by the fact that it also comprises two reinforcing parts, right and left, that are shaped so as to be highly resistant to buckling, and are fixedly secured to sub-portions of a supporting element and of a first lateral end which are associated with one another in order to allow the transmission between supporting elements of a portion of a transverse force absorbed by one of them in the event of the front end of the associated upper arm being subjected to an impact.

By virtue of said transmission of transverse forces between supporting elements, in the event of a partial frontal impact of the vehicle at high speed against a rigid object, the vehicle's behavior is significantly improved and the vehicle is therefore able to avoid (or minimally avoid) being embedded in said rigid object.

The structure may comprise other features which can be taken separately or in combination, and especially:
each of its reinforcing parts can be shaped so as to match respective sub-portions of the supporting elements and first lateral end which are associated with one another;
it may comprise a transverse strut bar comprising right and left second lateral ends that are opposite and each fixedly secured to an upper face of a support part, itself fixedly secured to an upper face of an associated supporting element. In this case, each of the reinforcing parts can be installed against a lower face of a sub-portion of an associated first lateral end and against an inner face of an associated supporting element, and comprises a front sub-portion fixedly secured by screwing into a sub-portion of a corresponding support part;
in the case of the last option, the front sub-portion of each reinforcing part may have an edge at an acute angle relative a transverse direction of the vehicle;
each of its reinforcing parts can be fixedly secured to a supporting element and a first lateral end which are associated with another by screwing and/or welding;
each of its reinforcing parts may comprise a lower tab extending downwards and bearing against a lateral inner face of the supporting element to which it is fixedly secured;
each of its reinforcing parts can be made of high-strength steel;
each of its reinforcing parts can have a thickness of between 1 mm and 2 mm;
each of its reinforcing parts can be shaped by stamping and/or bending.

Described herein is a land vehicle, optionally of the motor vehicle type, and comprising a front portion comprising a structure of the type of that presented hereinabove.

### BRIEF DESCRIPTION OF THE FIGURES

Other features and advantages will become apparent on examining the detailed description below, and the appended drawings (obtained using CAD (Computer-Assisted Design)), wherein:

FIG. 1 schematically shows, in a front perspective view, a front portion of a land vehicle comprising an example embodiment of a structure.

FIG. 2 schematically shows, in a front perspective view, a left sub-portion of the structure shown in FIG. 1.

FIG. 3 schematically shows, in a perspective view from above, a right-hand reinforcing part of the structure shown in FIG. 1.

FIG. 4 schematically shows, in a perspective view from below, the left-hand reinforcing part secured to the left-hand supporting element and to the first left-hand lateral end of the transverse stiffener of the structure shown in FIG. 1.

### DETAILED DESCRIPTION

One of the aims is notably to provide a structure SV for use as part of the front portion of a land vehicle, to improve the vehicle's behavior in the event of a partial frontal (or small overlap) impact with a rigid object.

In what follows, the structure SV is considered, by way of non-limiting example, to be part of a land vehicle of the motor vehicle type, such as for example a car. However, the described devices are not limited to this type of land vehicle. Indeed, they apply to any land vehicle comprising a front portion having a structure designed to absorb impacts, particularly partial frontal (or small overlap) impacts.

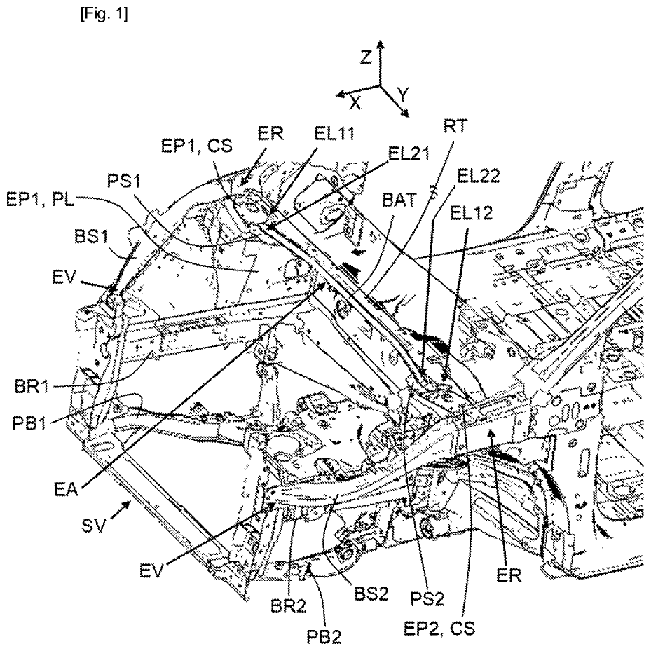

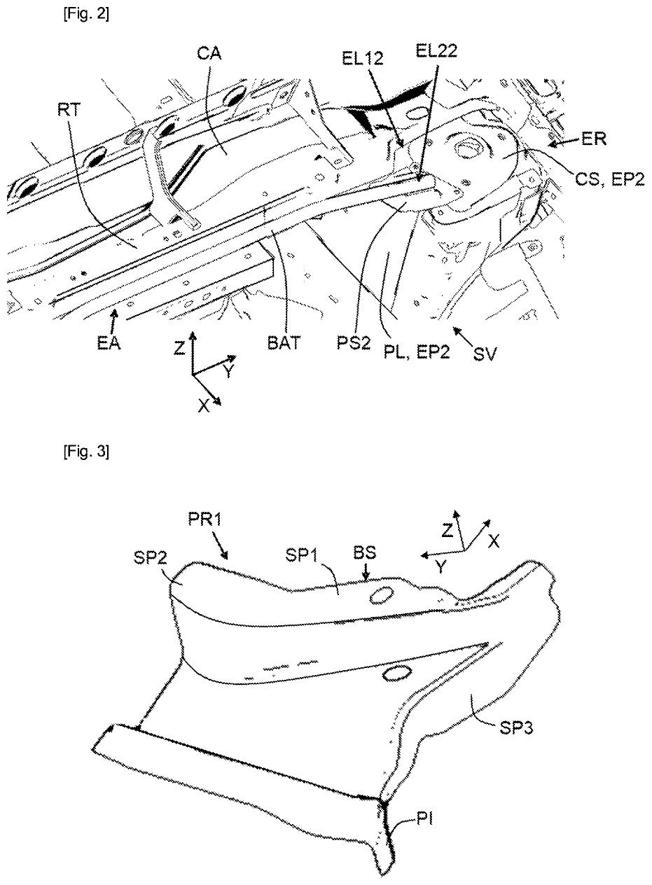

In FIGS. 1 to 4, the X direction is the longitudinal direction of the vehicle, which is parallel to the lateral sides comprising the side doors, the Y direction is the transverse direction of the vehicle, which is perpendicular to the longitudinal X direction, and the Z direction is the vertical direction of the vehicle, which is perpendicular to the longitudinal X and transverse Y directions.

As mentioned in the introductory section, FIG. 1 schematically shows a front portion of a vehicle comprising an example embodiment of a structure SV. As shown partially in FIGS. 1, 3 and 4, a structure SV, notably comprises two upper arms BSj, right (j=1) and left (j=2), two supporting elements EPj, right (j=1) and left (j=2), a transverse stiffener RT, and two reinforcing parts PRj, right (j=1) and left (j=2).

The two upper arms BSj each comprise front ends EV and rear ends ER, and are herein located above two shafts BRj, right (j=1) and left (j=2), which are also part of the structure SV. Note that these two shafts BRj are herein themselves positioned above two frame extensions PBj. The front ends EV of the two upper arms BSj are herein coupled respectively to the front ends of the two shafts BRj.

In the foregoing and the following, “front” is defined in relation to the front end of the vehicle, and “rear” is defined in relation to the rear end of the vehicle (opposite the front end). Consequently, the front part of an element is (intended to be) oriented towards the front end of the vehicle, while the rear part of said element is (intended to be) oriented towards the rear end of the vehicle. Furthermore, a first element is said to be positioned in front of a second element when said first element is located closer to the front end of the vehicle than the second element.

The rear ends ER of the upper arms BSj are fixedly secured respectively to the two supporting elements EPj in an upper end part of the two supporting elements (EPj).

Each supporting element EPj notably comprises a substantially vertical side wall PL, terminated by a suspension cup CS to which a front suspension of the vehicle is secured.

The transverse stiffener RT has its greatest extension along the transverse direction Y of the vehicle. It is preferably made of metal, for example steel or aluminum. For example, and as shown without limitation in FIG. 1, the transverse stiffener RT may be part of a canopy assembly EA which also comprises a collector CA and a transverse strut bar BAT.

This transverse stiffener RT comprises first lateral ends EL1j that are opposite one another and fixedly secured to the supporting elements EPj, respectively, in the upper end portion of the two supporting elements (EPj).

The transverse strut bar BAT has its greatest extension along the transverse Y direction of the vehicle. It is preferably made of metal, for example steel or aluminum. Furthermore, it is preferably welded to the transverse stiffener RT.

As shown as a non-limiting example in FIG. 1, this transverse strut bar BAT comprises two second lateral ends EL2j that are opposite and coupled respectively to the supporting elements EPj, in the upper end portion of the two supporting elements (EPj). For example, this coupling can be made via two support parts PSj. In this case, the two support parts PSj are fixedly secured respectively to the upper faces of the two supporting elements EPj and to the lower faces of the two second lateral ends EL2j, as shown without limitation in FIG. 1.

For example, and as shown without limitation in FIG. 4, each support part PSj can be fixedly secured to the upper face of the suspension cup CS of the associated supporting element EPj.

Each of the two reinforcing parts PRj is shaped to be highly resistant to buckling, and therefore subject to very little deformation along the longitudinal direction X when subjected to a force (or stress) having a main component along this longitudinal direction X (which is typically the case when the structure SV thereof is subjected to a partial frontal (or small overlap) impact against a rigid object.

It will be understood that it is mainly the particular shape of each reinforcing part PRj that enables it to have a high resistance to buckling. For example, in this particular shape, certain sub-portions can mutually extend by around 90°. Also, for example, said particular shape of each of the reinforcing parts PRj may result from stamping and/or bending.

In addition, each of the two reinforcing parts PRj is fixedly secured to sub-portions of a supporting element EPj and first lateral end EL1j which are associated with one another in order to allow the transmission between supporting elements EPj of a portion of a transverse force absorbed by one of them in the event of the front end EV of the associated upper arm BSj being subjected to an impact.

When the right-hand supporting element EP1 absorbs a transverse force resulting from the associated right-hand upper arm BS1 being subjected to an impact, the right-hand reinforcing part PR1 significantly limits, or even prevents, the deformation thereof, as do those of the associated first EL11 and second EL21 right-hand lateral ends, which allows the transmission to the left-hand supporting element EP2 of a portion of said absorbed transverse force. Conversely, when the left-hand supporting element EP2 absorbs a transverse force resulting from the associated left-hand upper arm BS2 being subjected to an impact, the left-hand reinforcing part PR2 significantly limits, or even prevents, the deformation thereof, as do those of the associated first EL12 and second EL22 left-hand lateral ends, which allows the transmission to the right-hand supporting element EP1 of a portion of said absorbed transverse force.

Thus, when the vehicle is traveling at high speed and is subjected to a partial frontal (or small overlap) impact with a rigid object, such as for example a wall, the transverse stiffener RT and any transverse strut bar BAT can transmit the transverse force experienced by one supporting element EPj to the other supporting element EPj′, thereby significantly improving the vehicle's behavior and preventing it from being embedded (or minimally embedded) in said rigid object.

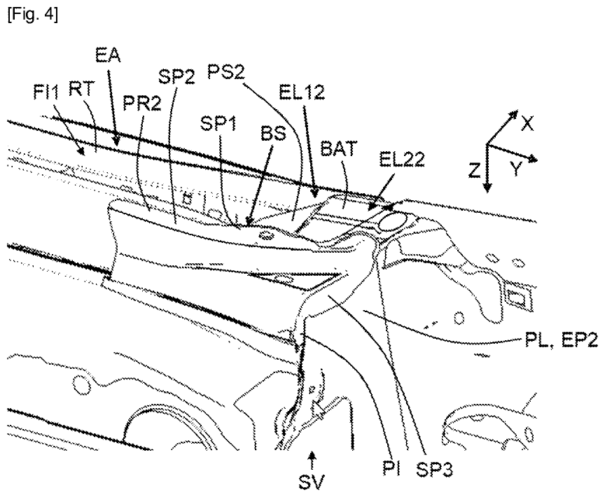

As can be seen, at least in partially in FIGS. 3 and 4, each of the reinforcing parts PRj can be shaped to match respective sub-portions of the associated supporting element EPj and first lateral end EL1j. This minimizes the clearances therebetween, therefore further enhancing their ability to avoid mutual deformation and therefore the transmission of transverse forces between supporting elements EPj.

For example, and as shown as a non-limiting example, in FIG. 4 in the presence of the transverse strut bar BAT described herein before, each of the reinforcing parts PRj can be installed against the lower face Fl1 of a sub-portion of an associated first lateral end EL1j and against the lateral inner face FI2 (herein substantially vertical) of an associated supporting element EPj. In other words, each reinforcing part PRj is installed under the associated first lateral end EL1j and on the inside of the associated supporting element EPj. Each reinforcing part PRj then comprises a sub-portion SP2 secured to the lower face FI1 of a sub-portion of a first lateral end EL1j and another sub-portion SP3 secured to the lateral inner face FI2 of a supporting element EPj.

Furthermore, each of the reinforcing parts PRj can comprise a front sub-portion SP1 which is fixedly secured by screwing into a sub-portion of the corresponding support part PSj. A fixed connection by welding is also possible. Said fixed connection limits (or even prevents) the deformation of a reinforcing part PRj (and therefore of a second lateral end EL2j) that may be caused by the supporting element EPj, and therefore increases the ability to transmit transverse forces between supporting elements EPj.

Also by way of example, and as shown without limitation in FIGS. 3 and 4, the front sub-portion SP1 of each reinforcing part PRj may have an edge BS which makes an acute angle relative to the transverse direction Y. This further reduces the possibility of mutual deformations and thus further increases the ability to transmit transverse forces between supporting elements EPj. Furthermore, each front sub-portion SP1 thus defines a “wing” projecting forwards from the lower face FI1 of the associated first lateral end EL1j and facilitating the securing of the associated reinforcing part PRj.

The acute angle may, for example, be between 20° and 60°. By way of illustration, it may be approximately 45°.

Also, for example, each of the reinforcing parts PRj can be fixedly secured to an associated supporting element EPj and first lateral end EL1j by screwing and/or welding. For example, each of the reinforcing parts PRj can be fixedly secured to a supporting element EPj by welding and to a first lateral end EL1j by screwing and welding. Also by way of example, and as shown without limitation in FIGS. 3 and 4, each of the reinforcing parts PRj may comprise a lower tab PI which extends downwards and bears against the lateral inner face FI2 of the supporting element EPj to which it is fixedly secured. This makes it possible to increase the bearing surface of each supporting element EPj on the associated reinforcing part PRj, and therefore further reduce its deformability, without significantly penalizing the weight of this reinforcing part PRj.

Also, for example, each of the reinforcing parts can be made from a steel with a high yield strength (or HSS), that is, typically greater than 355 MPa. The steel can be either very high strength (VHSS) or ultra high strength (UHSS).

Also by way of example, each of the reinforcing parts PRj can have a thickness of between 1 mm and 2 mm. By way of illustration, this thickness may be equal to 1.2 mm.

1. A structure suitable for being fitted to a land vehicle and comprising a front portion having i) right and left upper arms, each of which comprises front ends and rear ends, ii) right and left supporting elements, to which said rear ends are respectively fixedly secured, and iii) a transverse stiffener having first lateral ends that are opposite and fixedly secured to said supporting elements respectively, wherein the structure further comprises two reinforcing parts, right and left, that are shaped so as to be highly resistant to buckling, and are fixedly secured to sub-portions of a supporting element and first lateral end which are associated with one another in order to allow the transmission between supporting elements of a portion of a transverse force absorbed by one of them in the event of the front end of said associated upper arm being subjected to an impact.

2. The structure according to claim 1, wherein each of said reinforcing parts is shaped so as to match respective shapes of sub-portions of said supporting element and first lateral end which are associated with one another.

3. The structure according to claim 1, wherein the structure comprises a transverse strut bar comprising right and left second lateral ends that are opposite and each fixedly secured to an upper face of a support part which is fixedly secured to an upper face of an associated supporting element, and in that each of said reinforcing parts is installed against a lower face of a sub-portion of an associated first lateral end and against a lateral inner face of an associated supporting element, and comprises a front sub-portion fixedly secured by screwing into a sub-portion of a corresponding support part.

4. The structure according to claim 3, wherein said front sub-portion of each reinforcing part has an edge forming an acute angle relative to a transverse direction of said vehicle.

5. The structure according to claim 1, wherein each of said reinforcing parts is fixedly secured to a supporting element and a first lateral end which are associated with one another by screwing and/or welding.

6. The structure according to claim 1, wherein each of said reinforcing parts comprises a lower tab extending downwards and bearing against a lateral inner face of said supporting element to which it is fixedly secured.

7. The structure according to claim 1, wherein each of said reinforcing parts is made of high-strength steel.

8. The structure according to claim 1, wherein each of said reinforcing parts has a thickness of between 1 mm and 2 mm.

9. The structure according to claim 1, wherein each of said reinforcing parts is shaped by stamping and/or bending.

10. A land vehicle comprising a front portion, wherein said front portion comprises the structure according to claim 1.
